(19) United States
(12) Patent Application Publication
(10) Pub. No.: US 2005/0082013 A1
(43) Pub. Date: Apr. 21, 2005

(54) Protective tire shield

(76) Inventor: Joel M. White, Edson (CA)

Correspondence Address: Glen F. Gallinger, 7420 Milner Dr. #1000, Colorado Spring, CO, 80920, US

(21) Appl. No.: 10/685,682

(22) Filed: Oct. 16, 2003

(51) Int. Cl. B60C 1/00

(52) U.S. Cl. 157/1

(57) ABSTRACT

The apparatus which protects from an explosive air blast when inflating a wheel comprises: a frame having a front side, a back side, a top side and an end portion for entry of the wheel into the cage; a transparent shield positioned on an interior front side of the frame to allow for convenient inspection of the wheel after the wheel is inflated, and to prevent the explosive air blast from passing through the front side of the cage to the technician; and, a central opening through the shield to allow the technician to access the valve on the wheel. The apparatus can be adapted to be anchored to a supporting structure so that in the event of an explosion the cage will remain stationary. A method of inflating a tire on a comprises the steps of: a) providing a tire safety cage as above; b) rolling the wheel to be inflated into the cage; c) accessing the valve on the wheel with an air hose through the central opening in the shield and inflating the tire to required air pressure; d) observing the pressurized wheel in the cage through the shield for a period of time to ensure that the tire will safely hold air; and finally, e) rolling the wheel out of the cage.

### FIELD OF THE INVENTION

This invention relates to steel tire cages used for safety when inflating truck tires. More particularly this invention relates to a tire safety cage having a front transparent shield to protect a tire technician from a tire or wheel explosion.

### BACKGROUND OF THE INVENTION

Medium size truck tires are normally inflated to a pressure of 100 psi. When a tire is inflated generally accepted safety procedures mandate positioning the wheel inside a tire safety cage prior to inflating it to pressure. Tire cages are used to prevent serious injury or damage to property in the event of a tire failure and explosion.

The inventor herein suffered 4 broken bones and 14 stitches on his face when he inflated a tire in a safety cage. The side wall of the tire failed. Apparently the tire had been internally damaged when it had been driven with insufficient pressure. The safety cage prevented the tire from striking him. However, the air blast—of some 30,000 pounds—passed through the cage and knocked him over. More recently, a man in Fairview, Alberta, was killed as a direct result of a tire explosion which occurred while he was inflating a tire. He was not using a tire cage. The inventor was fortunate he was using a tire cage. However, the inventor would have been considerably more fortunate if the tire cage he was using had included a tire shield to protect him from the destructive air blast.

### OBJECTS OF THE INVENTION

It is an object of this invention to improve the safety of a tire cage. It is an object of this invention to prevent injury to tire technicians resulting from an air blast caused by an exploding tire. It is yet a further object of this invention to disclose an improved tire cage having a shield capable of protecting a technician from an air blast received from an exploding tire.

One aspect of this invention provides for a tire safety cage to protect a technician from an explosive air blast when inflating a wheel through its valve comprising: a frame having a front side, a back side, a top side and an end portion for entry of the wheel into the cage; a transparent shield positioned on an interior front side of the frame to allow for convenient inspection of the wheel after the wheel is inflated, and to prevent the explosive air blast from passing through the front side of the cage to the technician; and, a central opening through the shield to allow the technician to access the valve on the wheel.

In a preferred aspect of this invention the cage is adapted to be anchored to a supporting structure so that in the event of an explosion the cage will remain stationary.

A method of inflating a tire on a wheel having a valve comprising the steps of: a) providing a tire safety cage having a front side, a back side, a top side, and an end portion for entry of the wheel into the cage, said cage having a transparent shield positioned on an interior front side of the cage, said shield having a central opening therethrough; b) rolling the wheel to be inflated into the cage; c) accessing the valve on the wheel with an air hose through the central opening in the shield and inflating the tire to required air pressure; d) observing the pressurized wheel in the cage through the shield for a period of time to ensure that the tire will safely hold air; and finally, e) rolling the wheel out of the cage.

Various other objects, advantages and features of this invention will become apparent to those skilled in the art from the following description in conjunction with the accompanying drawings.

### FIGURES OF THE INVENTION

FIG. 1 is a perspective view of a wheel positioned in a tire cage.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

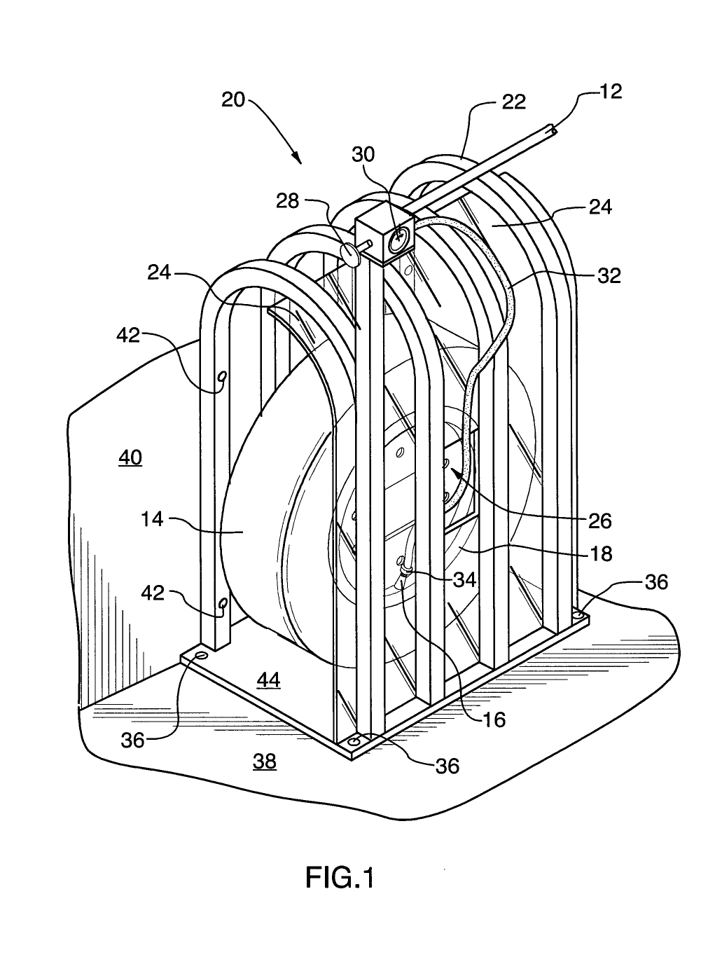

Turning now to the drawings and more particularly to FIG. 1 we have a perspective view of a wheel 18 positioned in a tire cage 20. The tire safety cage 20 protects a technician from an explosive air blast when inflating the wheel 18 through its valve 16. The tire cage comprises: a frame 22 having a front side, a back side, a top side and an end portion for entry of the wheel 18 into the cage 20; a transparent shield 24 positioned on an interior front side of the frame to allow for convenient inspection of the wheel 18 after it is inflated, and to prevent the explosive air blast from passing through the front side of the cage 20 to the technician; and, a central opening 26 through the shield 24 to allow the technician to access the valve 16 on the wheel 18.

In a preferred embodiment of the invention the cage 20 further comprises a pressure regulator 28 having an air pressure gauge 30 which are carried by the frame 22. The pressure regulator 28 has a low pressure air hose 32 which extends therefrom and which has a valve chuck 34 on an unattached end portion so that air pressure can be limited to required maximum tire pressure, thereby preventing over inflation of the wheel 18. The frame 22 is constructed from tubular steel and the shield 24 comprises clear plastic. The shield could be PLEXIGLASS™, LEXAN™, or any other clear polycarbonate which could withstand extreme pressure.

In the most preferred embodiment of the invention the cage's 20 bottom side portion comprises plate steel 44. ¼″ thick plate steel would be adequate. Most preferably, the cage 20 has corner bolt holes 36 in its bottom side portion to facilitate anchoring to a floor 38. Alternatively, or additionally, the cage 20 may be anchored to a rear wall 40 if the back side portion of the cage 20 has upper and lower end bolt holes 42 which extend through the frame 22.

Additionally, in the most preferred embodiment of the invention the cage's 20 top portion is semi-circular when viewed from an end and the front shield extends upwardly around a front portion of the top portion to prevent an explosive air blast from injuring a standing technician.

A basic method of inflating a tire 14 on a wheel 18 having a valve 16 comprises the steps of: a) providing a tire safety cage 20 having a front side, a back side, a top side, and an end portion for entry of the wheel 18 into the cage 20; said cage having a transparent shield 24 positioned on an interior front side of the cage 22, said shield having a central opening 26 therethrough; b) rolling the wheel 18 to be inflated into the cage 20; c) accessing the valve 16 on the wheel 18 with an air hose 32 through the central opening 26 in the shield 24; c) inflating the tire 14 to required air pressure; d) observing the pressurized wheel 18 in the cage 220 through the shield 24 for a period of time to ensure that the tire 14 will safely hold air; and finally d) rolling the wheel 18 out of the cage 20.

In a preferred embodiment of this method the cage 20 carries a pressure regulator 28 having an air pressure gauge 30, The pressure regulator 28 has a low pressure hose 32 extending therefrom which has a valve chuck 34 on an unattached end portion. The method further comprises the steps of a) connecting an air pressure supply line 12 to the pressure regulator 28; b) adjusting the pressure regulator 28 to display the maximum tire pressure in the air pressure gauge 30; and then, c) using the low pressure hose 32 and valve chuck 34 to inflate the tire 14 through the central opening 26.

A preferred aspect of the basic method further comprises the step of anchoring the cage 20 to a supporting structure, which may be a floor 38 or rear wall 40, to ensure that in the event of an explosion the cage 20 remains stationary.

While the invention has been described with preferred specific embodiments thereof, it will be understood that this description is intended to illustrate and not to limit the scope of the invention, which is defined by the following claims.

1) A tire safety cage to protect a technician from an explosive air blast when inflating a wheel through its valve comprising:
a frame having a front side, a back side, a top side and an end portion for entry of the wheel into the cage;
a transparent shield positioned on an interior front side of the frame to allow for convenient inspection of the wheel after the wheel is inflated, and to prevent the explosive air blast from passing through the front side of the cage to the technician; and,
a central opening through the shield to allow the technician to access the valve on the wheel.

2) A cage as in claim 1 having further comprising a pressure regulator having an air pressure gauge carried by the frame, said pressure regulator having a low pressure air hose extending therefrom which has a valve chuck on an unattached end portion so that air pressure can be limited to required maximum tire pressure thereby preventing over inflation of the wheel.

3) A cage as in claim 2 wherein the frame is constructed from tubular steel and wherein the shield comprises clear plastic.

4) A cage as in claim 1 further comprising a bottom side portion.

5) A cage as in claim 4 wherein the bottom side portion comprises plate steel.

6) A cage as in claim 4 wherein the bottom side portion of the cage has corner bolt holes in its bottom side portion to facilitate anchoring to a floor.

7) A cage as in 3 wherein the back side portion of the cage has upper and lower end bolt holes which extend through the frame to facilitate anchoring to a rear wall.

8) A cage as in claim wherein a top portion of the cage is semi-circular when viewed from an end thereof, and wherein the front shield extends upwardly around a front portion of the top portion to prevent an explosive air blast from injuring a technician standing in front of the cage.

9) A method of inflating a tire on a wheel having a valve comprising the steps of:
providing a tire safety cage having a front side, a back side, a top side, and an end portion for entry of the wheel into the cage, said cage having a transparent shield positioned on an interior front side of the cage, said shield having a central opening therethrough;
rolling the wheel to be inflated into the cage;
accessing the valve on the wheel with an air hose through the central opening in the shield and inflating the tire to required air pressure;
observing the pressurized wheel in the cage through the shield for a period of time to ensure that the tire will safely hold air; and finally, rolling the wheel out of the cage.

10) A method as in claim 9 wherein the cage carries a pressure regulator and an air pressure gauge, and wherein said pressure regulator has a low pressure hose extending therefrom which has a valve chuck on an unattached end portion; and
further comprising the steps of connecting an air pressure supply line to the pressure regulator; adjusting the pressure regulator to display the maximum tire pressure in the air pressure gauge; and then, using the low pressure hose and valve chuck to inflate the tire through the central opening.

11) A method as in claim 9 further comprising the step of anchoring the cage to a supporting structure to ensure that in the event of an explosion the cage remains stationary.
